(19) United States
(12) Patent Application Publication
(10) Pub. No.: US 2009/0271313 A1
(43) Pub. Date: Oct. 29, 2009

(54) METHOD AND SYSTEM FOR BALANCE ACCOUNT UTILIZATION

(75) Inventors: Hardik Chaudhari, San Francisco, CA (US); Annupreet Sidana, Palo Alto, CA (US)

Correspondence Address: SCHWEGMAN, LUNDBERG & WOESSNER/EBAY, P.O. BOX 2938, MINNEAPOLIS, MN, 55402, US

(73) Assignee: EBAY, INC., SAN JOSE, CA (US)

(21) Appl. No.: 12/108,808

(22) Filed: Apr. 24, 2008

(51) Int. Cl. G06Q 40/00

(52) U.S. Cl. 705/39

(57) ABSTRACT

Methods and system for balance account utilization are described. In one embodiment, a balance account may be linked to a credit card account of a user. A determination of whether there is an amount due for the credit card account may be made. A determination of whether at least a minimum payment has been received for the amount due by a due date may be made. Funds from the balance account may be accessed based on the linking and a failure to receive at least the minimum payment by the due date. A balance payment may be processed on the due date for the credit card account with the funds from the balance account.

### BACKGROUND

A credit card user that fails to make a minimum balance payment by a due date may be penalized. The penalty may include an increased interest rate, a fee, a recordation of the late payment in the credit history of the user, or the like.

### BRIEF DESCRIPTION OF THE DRAWINGS

Some embodiments are illustrated by way of example and not limitation in the figures of the accompanying drawings in which:

FIG. 1 is a block diagram of a system, according to example embodiments;

FIG. 2 is a block diagram of an example payment processing subsystem that may be deployed within the system of FIG. 1 according to an example embodiment;

FIGS. 3-7 are example flowcharts illustrating a method for balance account utilization according to example embodiments;

FIG. 8 is a network diagram depicting a network system, according to one embodiment, having a client server architecture configured for exchanging data over a network;

FIG. 9 is a block diagram illustrating an example embodiment of multiple network and marketplace applications, which are provided as part of the network-based marketplace; and

FIG. 10 is a block diagram diagrammatic representation of machine in the example form of a computer system within which a set of instructions for causing the machine to perform any one or more of the methodologies discussed herein may be executed.

### DETAILED DESCRIPTION

Example methods and systems for balance account utilization are described. In the following description, for purposes of explanation, numerous specific details are set forth in order to provide a thorough understanding of example embodiments. It will be evident, however, to one skilled in the art that embodiments of the present invention may be practiced without these specific details.

In an example embodiment, a balance account may be linked to a credit card account of a user. A determination of whether there is an amount due for the credit card account may be made. A determination of whether at least a minimum payment has been received for the amount due by a due date may be made. Funds from the balance account may be accessed based on the linking and a failure to receive at least the minimum payment by the due date. A balance payment may be processed on the due date for the credit card account with the funds from the balance account.

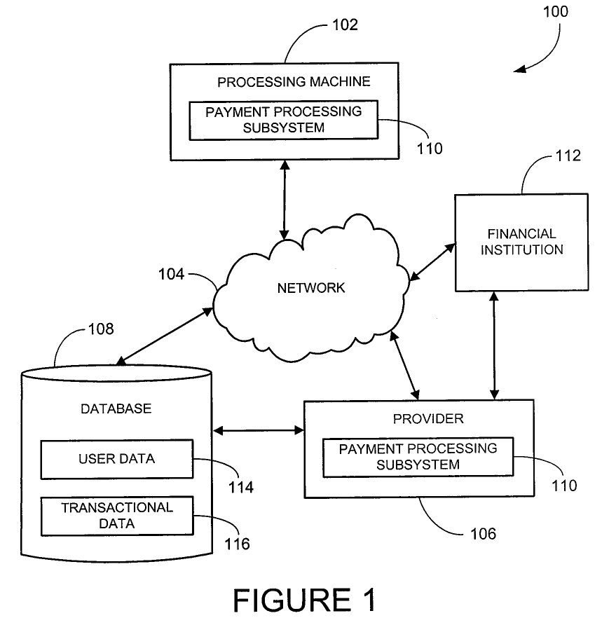

FIG. 1 illustrates an example system 100 in which a processing machine 102 may be in communication with a provider 106 over a network 104. An operator of the processing machine 102 may communicate with the provider 106 to manage a credit card account and a financial institution 112 to manage a balance account. Examples of the processing machine 102 include a banking terminal (e.g., a credit card machine), a set-top box (STB), a receiver card, a mobile telephone, a personal digital assistant (PDA), a display device, a portable gaming unit, and a computing system; however other devices may also be used. The user may operate the processing machine 102, or an operator may operate the processing machine 102 to facilitate the payment of the balance on behalf of the user.

The network 104 over which the processing machine 102, the provider 106, and the financial institution 112 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The provider 106 may manage a credit card account on behalf of the user. The provider 106 may be, by way of example, PayPal.com operated by eBay, Inc. or Chase.com operated by or JPMorgan Chase & Co. The provider 106 may include a payment processing subsystem 110 to, in one embodiment, receive a payment from a user. The provider 106 may also be in communication with a database 108. The database 108 may include user data 114 and/or transactional data 116. The user data 114 may include information regarding users of the provider 106. The transactional data 116 may include information regarding transactions conducted by the provider 106. For example, the sale of an item from one user to another may be stored in the transactional data 116.

The financial institution 112 may manage a balance account on behalf of the user that includes stored value (e.g., dollars). The financial institution 112 may be operated directly by the provider 106 (e.g., PayPal.com) or may be operated by a separate financial provider (e.g., US Bank).

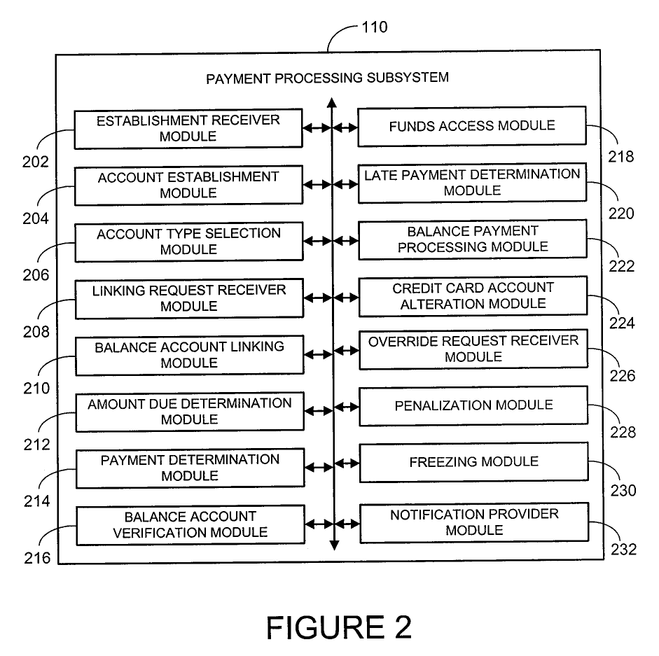

FIG. 2 illustrates an example payment processing subsystem 200 (see FIG. 1) that may be deployed in the processing machine 102 and/or the provider 106 of the system 100 or otherwise deployed in another system. The payment processing subsystem 200 may include an establishment receiver module 202, an account establishment module 204, an account type selection module 206, a linking request receiver module 208, a balance account linking module 210, an amount due determination module 212, a payment determination module 214, a balance account verification module 216, a funds access module 218, a late payment determination module 220, a balance payment processing module 222, a credit card account alteration module 224, an override request receiver module 226, a penalization module 228, a freezing module 230, and/or a notification provider module 232. Other modules may also be included.

The establishment receiver module 202 receives a request for credit card account establishment. The account establishment module 204 establishes the credit card account for the user. The credit card account may include a single annual percentage rate (APR) and/or no additional fees and be established for the user based on the linking. The credit card account may be established directly by the provider 106 or through communication with the financial institution 112.

The account type selection module 206 selects an account type for the credit card account that includes a single APR. The credit card account type may be selected directly by the provider 106 or through communication with the financial institution 112. The linking request receiver module 208 receives a linking request or a de-linking request from a user.

The balance account linking module 210 links a balance account to a credit card account of a user and/or de-links the balance account from the credit card account. The linking of the credit card to the balance account may be responsive to the receiving of the linking request. The balance account may include an electronic balance account, a savings account, a checking account and/or a money market account. The balance account may be associated with the user.

The amount due determination module 212 determines whether there is an amount due and/or an additional amount due for the credit card account. The payment determination module 214 determines whether at least a minimum payment has been received for the amount due and/or the additional amount due by a due date and/or whether a late payment has been received within a time period.

The balance account verification module 216 verifies that the balance account includes the funds to meet the minimum payment for the amount due and/or the additional amount due.

The funds access module 218 accesses funds from the balance account based on the linking and the minimum payment. The accessing of the funds may be based on the balance account including the funds to meet the minimum payment. The accessing of the funds may include sending a funds request to the financial institution 112 associated with the balance account and receiving the funds from the financial institution in response to the sending of the funds.

The late payment determination module 220 determines whether a previous late payment was received within a time period. The balance payment processing module 222 processes a balance payment on the due date for the credit card account with the funds from the balance account.

The credit card account alteration module 224 alters the credit card account based on the receiving of the de-linking request. The credit card account may be altered to include multiple APRs, additional late fees, a high APR, or the like for the user based on the receiving of the de-linking request. The multiple APRs may include, by way of example, a normal APR, a promotional APR, a cash advance APR, and the like. The override request receiver module 226 receives an override request from the user. The override request may be received to prevent funds from being accessed from the balance account.

The penalization module 228 penalizes the user based on the override request and a failure to receive at least the minimum payment for the additional amount by the due date. The freezing module 230 freezes the credit card account of the user based on the additional amount due, a failure to receive the additional amount due by the due date, the balance account not including the funds to meet the minimum payment for the additional amount due, and that the late payment has been received within the time period.

The notification provider module 232 provides a notification to the user that the minimum payment has not been received by the due date, provides a lateness forgiveness notification to the user, and/or provides a freezing notification to the user responsive to the freezing of the credit card account. Other notifications may also be provided by the notification provider module.

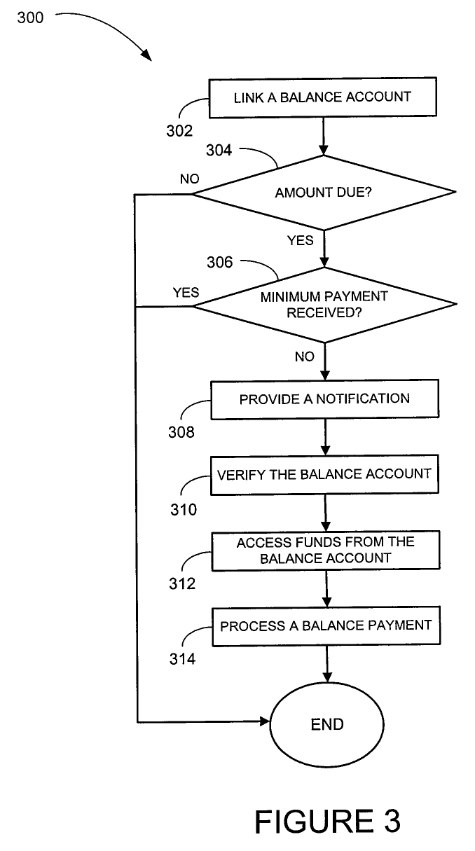

FIG. 3 illustrates a method 300 for balance account utilization according to an example embodiment. The method 300 may be performed by the processing machine 102 and/or the provider 106 of the system 100 (see FIG. 1) or otherwise performed.

A balance account is linked to a credit card account of a user at block 302. The balance account may include an electronic balance account, a savings account, a checking account, and/or a money market account. Other types of accounts that may include balances may also be used. The balance account may be associated with a same organization as the credit card account or a different organization. The balance account may be associated with the user or a different user (e.g. a parent of the user).

In an example embodiment, the balance account may be linked to the credit card account when a user applies for a credit card account, receives approval, and opts in for an auto-payment feature.

At decision block 304, a determination is made as to whether there is an amount due for the credit card account. If a determination is made that there is not an amount due, the method 300 may terminate. If a determination is made at decision block 304 that there is an amount due, the method 300 may proceed to decision block 306.

At decision block 306, a determination is made as to whether at least a minimum payment has been received from the user for the amount due by a due date. If a determination is made that at least the minimum payment has been received, the method 300 may terminate. If a determination is made that at least the minimum payment has not been received at decision block 306, the method 300 may proceed to block 308.

A notification may be provided to the user that the minimum payment has not been received by the due date at block 308. At block 310, verification may be made that the balance account includes the funds to meet the minimum payment for the amount due.

Funds from the balance account are accessed based on the linking and a failure to receive the minimum payment at block 312. The accessing may include, in one embodiment, sending a funds request to the financial institution 112 associated with the balance account and receiving the funds from the financial institution 112 in response to the sending of the funds. The accessing of the funds may be based on verification. At block 314, a balance payment is processed on the due date for the credit card account with the funds from the balance account.

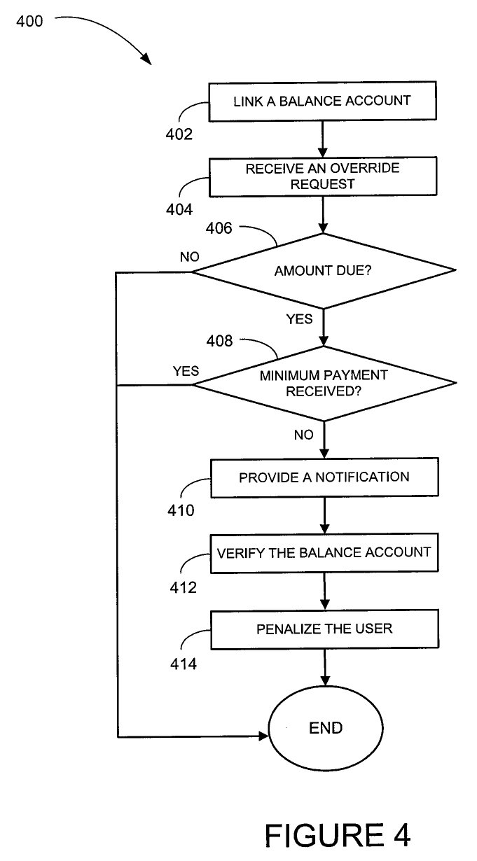

FIG. 4 illustrates a method 400 for balance account utilization according to an example embodiment. The method 400 may be performed by the processing machine 102 and/or the provider 106 of the system 100 (see FIG. 1) or otherwise performed.

A balance account is linked to a credit card account of a user at block 402. The balance account may include an electronic balance account, a savings account, a checking account, and/or a money market account. Other types of accounts that may include balances may also be used. The balance account may be associated with the user or a different user (e.g. a parent of the user). An override request may be received from the user at block 404.

At decision block 406, a determination is made as to whether there is an amount due for the credit card account. If a determination is made that there is not an amount due, the method 400 may terminate. If a determination is made at decision block 406 that there is an amount due, the method 400 may proceed to decision block 408.

At decision block 408, a determination is made as to whether at least a minimum payment has been received from the user for the amount due by a due date. If a determination is made that at least the minimum payment has been received, the method 400 may terminate. If a determination is made that at least the minimum payment has not been received at decision block 408, the method 400 may proceed to block 410.

A notification may be provided to the user that the minimum payment has not been received by the due date at block 410. The balance account may be verified at block 412. At block 414, the user may be penalized based on a failure to receive at least the minimum payment for the amount by the due date and the override request and/or insufficient value in the balance account to make at least the minimum payment. The penalty may include, by way of example, returning to a multiple APR credit card, charging the user a fee, or the like.

In an example embodiment, the operations at block 414 may be performed when the user overrides automatic minimum payment from the balance account, de-links the balance account, and/or has insufficient funds in the balance account. The operations performed at block 414 may be performed after a certain number of times (e.g., one or more times) that the minimum payment has not been received by the due date.

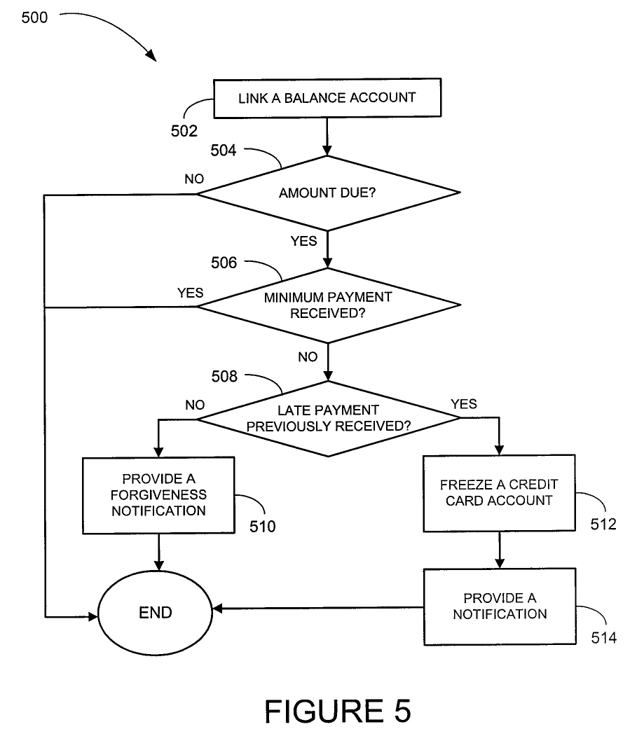

FIG. 5 illustrates a method 500 for balance account utilization according to an example embodiment. The method 500 may be performed by the processing machine 102 and/or the provider 106 of the system 100 (see FIG. 1) or otherwise performed.

A balance account is linked to a credit card account of a user at block 502. The balance account may include an electronic balance account, a savings account, a checking account, and/or a money market account. Other types of accounts that may include balances may also be used. The balance account may be associated with the user or a different user (e.g. a parent of the user).

At decision block 504, a determination is made as to whether there is an amount due for the credit card account. If a determination is made that there is not an amount due, the method 500 may terminate. If a determination is made at decision block 504 that there is an amount due, the method 500 may proceed to decision block 506.

At decision block 506, a determination is made as to whether at least a minimum payment has been received from the user for the amount due by a due date. If a determination is made that at least the minimum payment has been received, the method 500 may terminate. If a determination is made that at least the minimum payment has not been received at decision block 506, the method 500 may proceed to decision block 508.

At decision block 508, a determination may be made as to whether a previous late payment was received during a time period. The time period may be a number of calendar months, billable cycles, or the like. If a determination is made that a previous late payment has not be received within the time period, a lateness forgiveness notification may be provided to the user at block 510. The lateness notification may, in an example embodiment, advise a user that the minimum payment will be carried over to the next month, the user will not be charged a late fee, the user will not be charged an insufficient funds fee, or the like. The lateness forgiveness notification may be based on the additional amount due, a failure to receive the additional amount due by the due date, the balance account not including the finds to meet the minimum payment for the additional amount due, and that the late payment not having been received within the time period. If a determination is made that a previous late payment was received within the time period at decision block 508, the credit card account of the user may be frozen at block 512. The freezing of the account may be based on the additional amount due, a failure to receive the additional amount due by the due date, the balance account not including the funds to meet the minimum payment for the additional amount due, and that the late payment being received within the time period. A notification may be provided to the user responsive to the freezing of the credit card account at block 514.

In an example embodiment, the operations at block 512 may be performed when the user overrides automatic minimum payment from the balance account, de-links the balance account, and/or has insufficient funds in the balance account. The operations performed at block 512 may be performed after a certain number of times (e.g., one or more times) that the minimum payment has not been received by the due date.

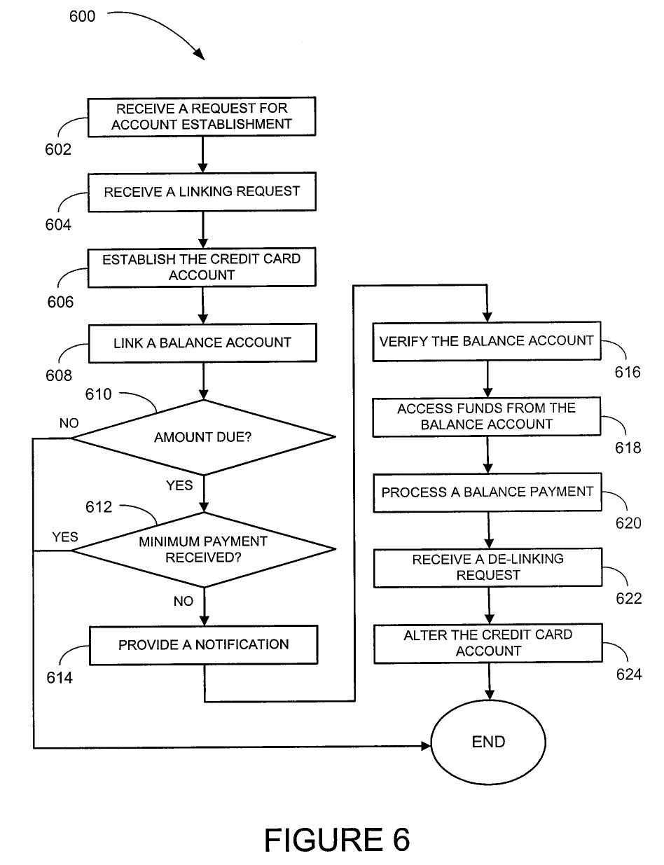

FIG. 6 illustrates a method 600 for balance account utilization according to an example embodiment. The method 600 may be performed by the processing machine 102 and/or the provider 106 of the system 100 (see FIG. 1) or otherwise performed.

A request for credit card account establishment may be received at block 602. A linking request may be received at block 604. At block 606, the credit card account may be established for the user including a single APR and/or no additional fees for the user based on the linking.

In an example embodiment, the linking of the balance account to the credit card account may enable the provider 106 to reduce risk associated with establishing the credit card account for the user. The reduction of the risk may enable the provider 106 to offer the credit card account with a single APR and/or no additional fees. The single APR may be offered at a lower interest rate than traditional interest rates because of the reduced risk.

A balance account is linked to a credit card account of a user at block 608. The balance account may include an electronic balance account, a savings account, a checking account, and/or a money market account. Other types of accounts that may include balances may also be used. The balance account may be associated with the user or a different user (e.g. a parent of the user).

At decision block 610, a determination is made as to whether there is an amount due for the credit card account. If a determination is made that there is not an amount due, the method 600 may terminate. If a determination is made at decision block 610 that there is an amount due, the method 600 may proceed to decision block 612.

At decision block 612, a determination is made as to whether at least a minimum payment has been received from the user for the amount due by a due date. If a determination is made that at least the minimum payment has been received, the method 600 may terminate. If a determination is made that at least the minimum payment has not been received at decision block 612, the method 600 may proceed to block 614.

A notification may be provided to the user that the minimum payment has not been received by the due date at block 614. At block 616, verification may be made that the balance account includes the funds to meet the minimum payment for the amount due.

Funds from the balance account are accessed based on the linking and a failure to receive the minimum payment at block 618. The accessing may include, in one embodiment, sending a funds request to a financial institution associated with the balance account and receiving the funds from the financial institution in response to the sending of the funds. The accessing of the funds may be based on verification.

At block 620, a balance payment is processed on the due date for the credit card account with the funds from the balance account. A de-linking request may be received from the user at block 622. At block 624, the credit card account may be altered to include multiple APRs, additional late fees, a high APR, or the like for the user based on the receiving of the de-linking request.

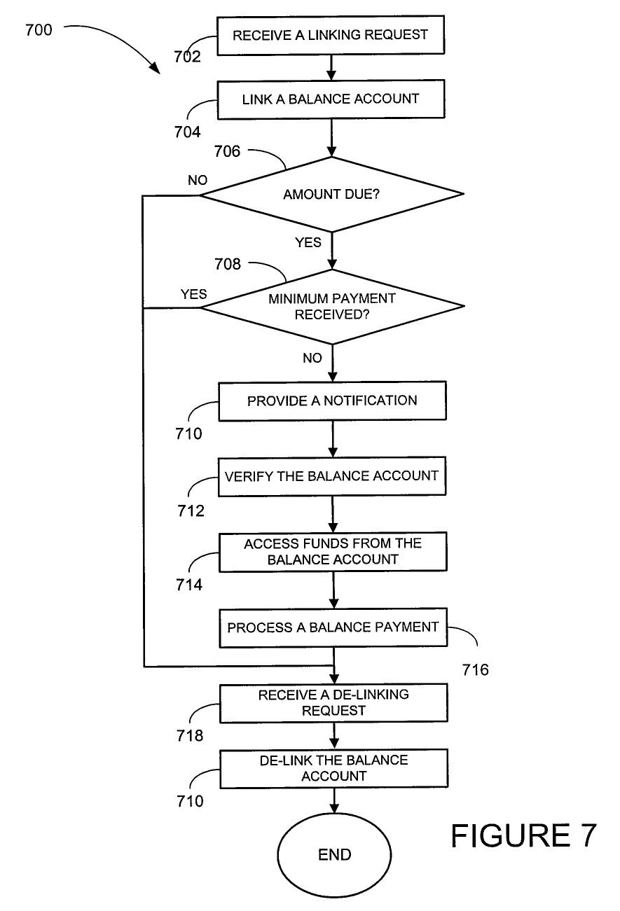

FIG. 7 illustrates a method 700 for balance account utilization according to an example embodiment. The method 700 may be performed by the processing machine 102 and/or the provider 106 of the system 100 (see FIG. 1) or otherwise performed.

A linking request may be received from a user at block 702. A balance account is linked to a credit card account of a user at block 704. The balance account may include an electronic balance account, a savings account, a checking account, and/or a money market account. Other types of accounts that may include balances may also be used. The balance account may be associated with the user or a different user (e.g. a parent of the user). The linking of the credit card to the balance account may be responsive to the receiving of the linking request

At decision block 706, a determination is made as to whether there is an amount due for the credit card account. If a determination is made that there is not an amount due, the method 700 may terminate. If a determination is made at decision block 706 that there is an amount due, the method 700 may proceed to decision block 708.

At decision block 708, a determination is made as to whether at least a minimum payment has been received for the amount due by a due date. If a determination is made that at least the minimum payment has been received, the method 700 may terminate. If a determination is made that at least the minimum payment has not been received at decision block 708, the method 700 may proceed to block 710.

A notification may be provided to the user that the minimum payment has not been received by the due date at block 710. At decision block 712, verification may be made that the balance account includes the funds to meet the minimum payment for the amount due.

Funds from the balance account are accessed based on the linking and a failure to receive the minimum payment at block 714. The accessing may include, in one embodiment, sending a funds request to a financial institution associated with the balance account and receiving the funds from the financial institution in response to the sending of the funds. The accessing of the funds may be based on verification.

At block 716, a balance payment is processed on the due date for the credit card account with the funds from the balance account. A request to de-link the balance request may be received at block 718. The balance account may be de-linked from the credit card account at block 720.

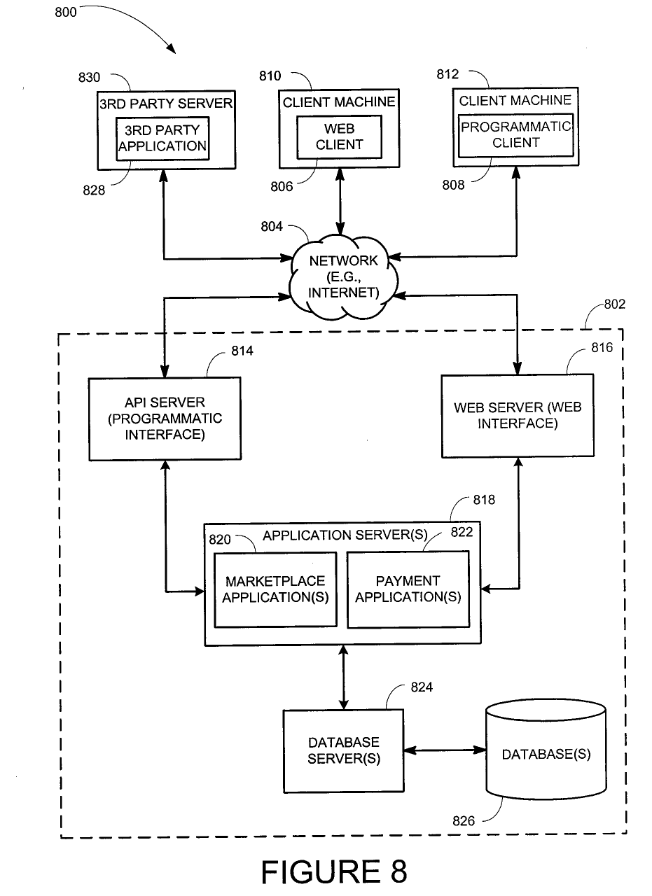

FIG. 8 is a network diagram depicting a client-server system 800, within which one example embodiment may be deployed. By way of example, a network 804 may include the functionality of the network 104, the provider 106 may be deployed within an application server 818, and the processing machine 102 may include the functionality of a client machine 810 or a client machine 812. The system 800 may also be deployed in other systems.

A networked system 802, in the example forms of a network-based marketplace or publication system, provides server-side functionality, via a network 804 (e.g., the Internet or Wide Area Network (WAN)) to one or more clients. FIG. 8 illustrates, for example, a web client 806 (e.g., a browser, such as the Internet Explorer browser developed by Microsoft Corporation of Redmond, Wash. State), and a programmatic client 808 executing on respective client machines 810 and 812.

An Application Program Interface (API) server 814 and a web server 816 are coupled to, and provide programmatic and web interfaces respectively to, one or more application servers 818. The application servers 818 host one or more marketplace applications 820 and authentication providers 822. The application servers 818 are, in turn, shown to be coupled to one or more databases servers 824 that facilitate access to one or more databases 826.

The marketplace applications 820 may provide a number of marketplace functions and services to users that access the networked system 802. The authentication providers 822 may likewise provide a number of payment services and functions to users. The authentication providers 822 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 820. While the marketplace and authentication providers 820 and 822 are shown in FIG. 8 to both form part of the networked system 802, in alternative embodiments the authentication providers 822 may form part of a payment service that is separate and distinct from the networked system 802.

Further, while the system 800 shown in FIG. 8 employs a client-server architecture, embodiments of the present invention are of course not limited to such an architecture, and could equally well find application in a distributed, or peer-to-peer, architecture system, for example. The various marketplace and authentication providers 820 and 822 could also be implemented as standalone software programs, which need not have networking capabilities.

The web client 806 accesses the various marketplace and authentication providers 820 and 822 via the web interface supported by the web server 816. Similarly, the programmatic client 808 accesses the various services and functions provided by the marketplace and authentication providers 820 and 822 via the programmatic interface provided by the API server 814. The programmatic client 808 may, for example, be a seller application (e.g., the TurboLister™ application developed by eBay Inc., of San Jose, Calif.) to enable sellers to author and manage listings on the networked system 802 in an off-line manner, and to perform batch-mode communications between the programmatic client 808 and the networked system 802.

FIG. 8 also illustrates a third party application 828, executing on a third party server machine 830, as having programmatic access to the networked system 802 via the programmatic interface provided by the API server 814. For example, the third party application 828 may, utilizing information retrieved from the networked system 802, support one or more features or functions on a website hosted by the third party. The third party may, for example, provide one or more promotional, marketplace or payment functions that are supported by the relevant applications of the networked system 802.

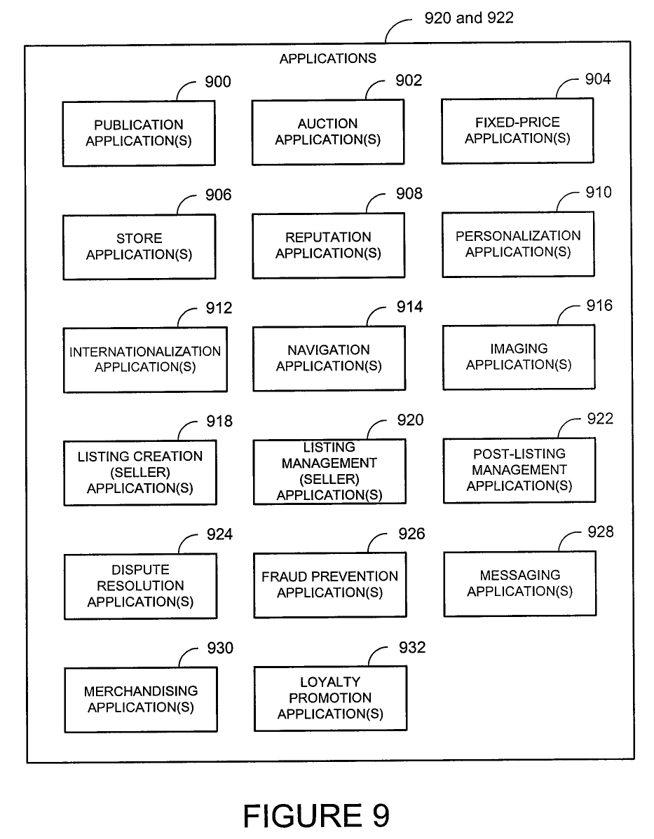

FIG. 9 is a block diagram illustrating multiple applications 820 and 822 that, in one example embodiment, are provided as part of the networked system 802 (see FIG. 8). The applications 820 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 826 via the database servers 824.

The networked system 802 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 820 are shown to include at least one publication application 900 and one or more auction applications 902 which support auction-format listing and price setting mechanisms (e.g., English, Dutch, Vickrey, Chinese, Double, Reverse auctions etc.). The various auction applications 902 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 904 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 906 allow a seller to group listings within a “virtual” store, which may be branded and otherwise personalized by and for the seller. Such a virtual store may also offer promotions, incentives and features that are specific and personalized to a relevant seller.

Reputation applications 908 allow users that transact, utilizing the networked system 802, to establish, build and maintain reputations, which may be made available and published to potential trading partners. Consider that where, for example, the networked system 802 supports person-to-person trading, users may otherwise have no history or other reference information whereby the trustworthiness and credibility of potential trading partners may be assessed. The reputation applications 908 allow a user, for example through feedback provided by other transaction partners, to establish a reputation within the networked system 802 over time. Other potential trading partners may then reference such a reputation for the purposes of assessing credibility and trustworthiness.

Personalization applications 910 allow users of the networked system 802 to personalize various aspects of their interactions with the networked system 802. For example a user may, utilizing an appropriate personalization application 910, create a personalized reference page at which information regarding transactions to which the user is (or has been) a party may be viewed. Further, a personalization application 910 may enable a user to personalize listings and other aspects of their interactions with the networked system 802 and other parties.

The networked system 802 may support a number of marketplaces that are customized, for example, for specific geographic regions. A version of the networked system 802 may be customized for the United Kingdom, whereas another version of the networked system 802 may be customized for the United States. Each of these versions may operate as an independent marketplace, or may be customized (or internationalized and/or localized) presentations of a common underlying marketplace. The networked system 802 may accordingly include a number of internationalization applications 912 that customize information (and/or the presentation of information) by the networked system 802 according to predetermined criteria (e.g., geographic, demographic or marketplace criteria). For example, the internationalization applications 912 may be used to support the customization of information for a number of regional websites that are operated by the networked system 802 and that are accessible via respective web servers 816.

Navigation of the networked system 802 may be facilitated by one or more navigation applications 914. For example, a search application (as an example of a navigation application) may enable key word searches of listings published via the networked system 802. A browse application may allow users to browse various category, catalogue, or system inventory structures according to which listings may be classified within the networked system 802. Various other navigation applications may be provided to supplement the search and browsing applications.

In order to make listings available via the networked system 802 as visually informing and attractive as possible, the marketplace applications 820 may include one or more imaging applications 916 utilizing which users may upload images for inclusion within listings. An imaging application 916 also operates to incorporate images within viewed listings. The imaging applications 916 may also support one or more promotional features, such as image galleries that are presented to potential buyers. For example, sellers may pay an additional fee to have an image included within a gallery of images for promoted items.

Listing creation applications 918 allow sellers conveniently to author listings pertaining to goods or services that they wish to transact via the networked system 802, and listing management applications 900 allow sellers to manage such listings. Specifically, where a particular seller has authored and/or published a large number of listings, the management of such listings may present a challenge. The listing management applications 900 provide a number of features (e.g., auto-relisting, inventory level monitors, etc.) to assist the seller in managing such listings. One or more post-listing management applications 902 also assist sellers with a number of activities that typically occur post-listing. For example, upon completion of an auction facilitated by one or more auction applications 802, a seller may wish to leave feedback regarding a particular buyer. To this end, a post-listing management application 902 may provide an interface to one or more reputation applications 908, so as to allow the seller conveniently to provide feedback regarding multiple buyers to the reputation applications 908.

Dispute resolution applications 914 provide mechanisms whereby disputes arising between transacting parties may be resolved. For example, the dispute resolution applications 914 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention applications 926 implement fraud detection and prevention mechanisms to reduce the occurrence of fraud within the networked system 802.

Messaging applications 928 are responsible for the generation and delivery of messages to users of the networked system 802, such messages for example advising users regarding the status of listings at the networked system 802 (e.g., providing “outbid” notices to bidders during an auction process or to provide promotional and merchandising information to users). Respective messaging applications 928 may utilize any one have a number of message delivery networks and platforms to deliver messages to users. For example, messaging applications 928 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 930 support various merchandising functions that are made available to sellers to enable sellers to increase sales via the networked system 802. The merchandising applications 930 also operate the various merchandising features that may be invoked by sellers, and may monitor and track the success of merchandising strategies employed by sellers.

The networked system 802 itself, or one or more parties that transact via the networked system 802, may operate loyalty programs that are supported by one or more loyalty/promotions applications 932. For example, a buyer may earn loyalty or promotions points for each transaction established and/or concluded with a particular seller, and may be offered a reward for which accumulated loyalty points can be redeemed.

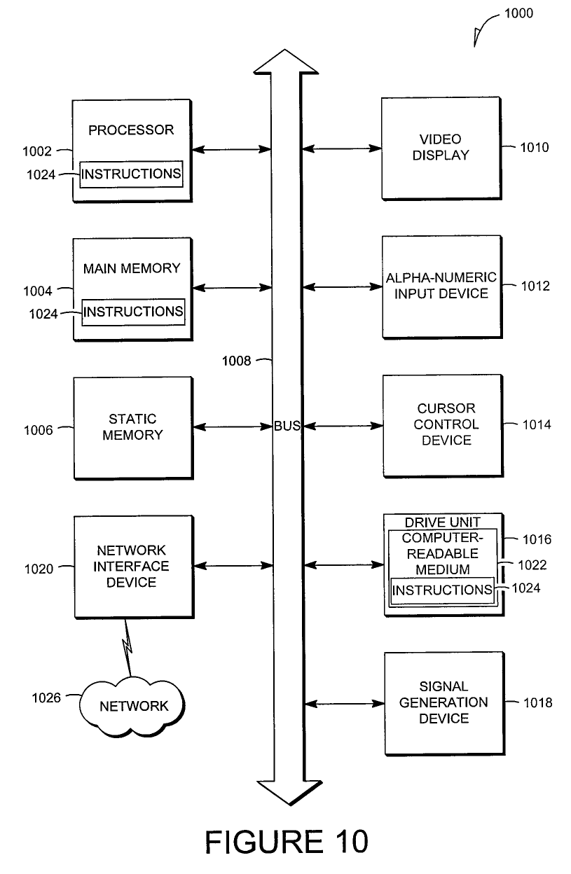

FIG. 10 shows a diagrammatic representation of machine in the example form of a computer system 1000 within which a set of instructions may be executed causing the machine to perform any one or more of the methods, processes, operations, or methodologies discussed herein. The provider 106 and/or the financial institution 112 may operate on or more computer systems 1000. The processing machine 102 may include the functionality of one or more computer systems 1000.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a drive unit 1016, a signal generation device 1018 (e.g., a speaker) and a network interface device 1020.

The drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for balance account utilization have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
linking a balance account to a credit card account of a user;
determining whether there is an amount due for the credit card account;
when there is an amount due, determining whether at least a minimum payment has been received for the amount due by a due date;
accessing finds from the balance account based on the linking and a failure to receive at least the minimum payment by the due date; and
processing a balance payment on the due date for the credit card account with the funds from the balance account.

2. The method of claim 1, further comprising:
verifying that the balance account includes the funds to meet the minimum payment for the amount due,
wherein the accessing of the funds is based on the linking, the failure to receive at least the minimum payment by the due date, and the verification.

3. The method of claim 1, wherein the accessing of the funds comprises:
sending a finds request to a financial institution associated with the balance account; and
receiving the funds from the financial institution in response to the sending of the funds.

4. The method of claim 1, further comprising:
receiving a linking request from a user,
wherein the linking of the credit card to the balance account is responsive to the receiving of the linking request.

5. The method of claim 1, further comprising:
establishing the credit card account for the user.

6. The method of claim 5, further comprising:
selecting an account type for the credit card account that includes a single annual percentage rate (APR).

7. The method of claim 1, wherein the balance account includes an electronic balance account, a savings account, a checking account, a money market account, or combinations thereof.

8. The method of claim 1, further comprising:
providing a notification to the user that the minimum payment has not been received by the due date.

9. The method of claim 1, further comprising:
receiving an override request from the user;
determining whether there is an additional amount due for the credit card account;
determining whether at least the minimum payment has been received for the additional amount due by the due date; and
penalizing the user based on the override request and a failure to receive at least the minimum payment for the additional amount by the due date.

10. The method of claim 1, further comprising:
determining whether there is an additional amount due for the credit card account;
determining whether at least the minimum payment has been received for the additional amount due by the due date;
determining whether the balance account includes the funds to meet the minimum payment for the additional amount due;
determining whether a late payment has been received within a time period; and
providing a lateness forgiveness notification to the user based on the additional amount due, a failure to receive the additional amount due by the due date, the balance account not including the funds to meet the minimum payment for the additional amount due, and that the late payment has not been received within the time period.

11. The method of claim 1, further comprising:
determining whether there is an additional amount due for the credit card account;
determining whether at least the minimum payment has been received for the additional amount due by the due date;
determining whether the balance account includes the funds to meet the minimum payment for the additional amount due;
determining whether a previous late payment was received within a time period; and
freezing the credit card account of the user based on the additional amount due, a failure to receive the additional amount due by the due date, the balance account not including the finds to meet the minimum payment for the additional amount due, and that the previous late payment was received within the time period.

12. The method of claim 11, further comprising:
providing a notification to the user responsive to the freezing of the credit card account.

13. The method of claim 1, further comprising:
receiving a request for credit card account establishment;
receiving a linking request; and
establishing the credit card account for the user including a single annual percentage rate (APR) for the user based on the linking.

14. The method of claim 13, wherein the establishing comprises:
establishing the credit card account including the single annual percentage rate (APR) and no additional fees for the user based on the linking.

15. The method of claim 14, further comprising:
receiving a de-linking request from a user; and
altering the credit card account to include multiple APR for the user based on the receiving of the de-linking request.

16. A machine-readable medium comprising instructions, which when implemented by one or more processors perform the following operations:
link a balance account to a credit card account of a user;
determine whether there is an amount due for the credit card account;
determine whether at least a minimum payment has been received for the amount due by a due date;
access funds from the balance account based on the link and a failure to receive at least the minimum payment by the due date; and
process a balance payment on the due date for the credit card account with the funds from the balance account.

17. The machine-readable medium of claim 16 further comprising instructions, which when implemented by one or more processors perform the following operations:
receive an override request from the user;
determine whether there is an additional amount due for the credit card account;
determine whether at least the minimum payment has been received for the additional amount due by the due date; and
penalize the user based on the override request and a failure to receive at least the minimum payment for the additional amount by the due date.

18. The machine-readable medium of claim 16 further comprising instructions, which when implemented by one or more processors perform the following operations:
determine whether there is an additional amount due for the credit card account;
determine whether at least the minimum payment has been received for the additional amount due by the due date;
determine whether the balance account includes the funds to meet the minimum payment for the additional amount due;
determine whether a late payment has been received within a time period; and
provide a lateness forgiveness notification to the user based on the additional amount due, a failure to receive the additional amount due by the due date, the balance account not including the funds to meet the minimum payment for the additional amount due, and that the late payment has not been received within the time period.

19. The machine-readable medium of claim 16 further comprising instructions, which when implemented by one or more processors perform the following operations:
determine whether there is an additional amount due for the credit card account;
determine whether at least the minimum payment has been received for the additional amount due by the due date;
determine whether the balance account includes the funds to meet the minimum payment for the additional amount due;
determine whether a late payment has been received within a time period; and
freeze the credit card account of the user based on the additional amount due, a failure to receive the additional amount due by the due date, the balance account not including the funds to meet the minimum payment for the additional amount due, and that the late payment has been received within the time period.

20. A system comprising:
a balance account linking module to link a balance account to a credit card account of a user;
an amount due determination module to determine whether there is an amount due for the credit card account;
a payment determination module to determine whether at least a minimum payment has been received for the amount due determined by the amount due determination module by a due date;
a funds access module to access funds from the balance account linked based on the linking by the balance account linking module and a failure to receive at least the minimum payment by the due date by the payment determination module; and
a balance payment processing module to processing a balance payment on the due date for the credit card account with the funds from the balance account linked by the balance account linking module.

21. The system of claim 20, further comprising:
an account establishment module to establish the credit card account for the user.

22. The system of claim 20, further comprising:
an account type selection module to select an account type for the credit card account that includes a single annual percentage rate (APR).
